(19) United States
(12) Patent Application Publication
(10) Pub. No.: US 2010/0120536 A1
(43) Pub. Date: May 13, 2010

(54) ENTERTAINING VISUAL TRICKS FOR ELECTRONIC BETTING GAMES

(76) Inventors: NATE J. CHATELLIER, Cheney, WA (US); DONALD L. EVANS, Spokane, WA (US); DAVID A. KRISE, Spokane, WA (US); MICHAEL J. KUHN, Spokane, WA (US)

Correspondence Address: DigiDeal Corporation, 5123 East Third Street, Spokane, WA, 99212, US

(21) Appl. No.: 12/268,398

(22) Filed: Nov. 10, 2008

(51) Int. Cl. A63F 9/24; A63F 13/00

(52) U.S. Cl. 463/40

(57) ABSTRACT

Entertaining visual tricks for electronic betting games are described. In one implementation, a system receives gesture input, such as finger motions, from a user interface of a player at an electronic game table. The system maps the gesture input to known tricks and maneuvers to animate the virtual game components used in the electronic betting game, such as virtual playing cards, betting chips, dice, dice cups, tiles, and so forth. In one mode, the system divides the gesture input into segments and maps each segment to movement information for the virtual game component, enabling the player to record a custom visual trick. A motion synthesizer can apply kinematics to impart realistic or imaginary motion to the virtual game components, which can then be displayed across one or more video displays.

### BACKGROUND

Part of game play in betting environments such as card rooms and casinos includes handling the game components, such as playing cards, betting chips, and dice, and demonstrating skill and manual dexterity by performing card maneuvers, chip tricks, artful dice throws, etc. Textual description and video demonstration of known tricks can be found online using a search engine. Card maneuvers and “chip tricks” can also be observed first-hand at casinos.

Description of a few chip tricks is now presented to underscore the mechanical dexterity and sometimes the acrobatic skill that is needed to execute a trick for a game component. However, tricks are not limited to those for betting chips.

In Mexican Jumping Chip, a chip “jumps” from one stack of chips to another. In Twirl Flick, the chip is tossed or “flicked” over the hand, across the body, and caught with the opposite hand. In Bounce Back, a chip is thrown up into the air with backspin. Once the chip bounces on a soft surface it then bounces back and is caught next to the other chips. In Drifter, a chip is slammed onto a surface so that it runs forward and the backspin created brings the chip back. In Lift Twirl, a chip is lifted onto the top of the index finger and then twirled. When the twirl is completed, the chip is lowered from the top of the index finger back down next to the other chips.

There are many other chip tricks, and also many tricks for other game components. What is needed is a way to enjoy these tricks on a digital electronic betting game platform.

### SUMMARY

Entertaining visual tricks for electronic betting games are described. In one implementation, a system receives gesture input, such as finger motions, from a user interface of a player at an electronic game table. The system maps the gesture input to known tricks and maneuvers to animate the virtual game components used in the electronic betting game, such as virtual playing cards, betting chips, dice, dice cups, tiles, and so forth. In one mode, the system divides the gesture input into segments and maps each segment to movement information for the virtual game component, enabling the player to record a custom visual trick. A motion synthesizer can apply kinematics to impart realistic or imaginary motion to the virtual game components, which can then be displayed across one or more video displays.

This summary section is not intended to give a full description of the visual tricks for electronic betting games, or to provide a list of features and elements. A detailed description of example embodiments of the electronic gaming system follows.

### BRIEF DESCRIPTION OF THE DRAWINGS

FIG. 1 is a top view of a multiplayer electronic game table that includes an exemplary visual trick engine.

FIG. 2 is a top view of another multiplayer electronic game table that includes the exemplary visual trick engine.

FIG. 3 is a block diagram of an exemplary game processing system, including an exemplary visual trick engine.

FIG. 4 is a block diagram of an exemplary networked game processing system, including the exemplary visual trick engine.

FIG. 5 is a block diagram of another exemplary networked game processing system, including the exemplary visual trick engine, in which each network node may be a multi-player electronic game.

FIG. 6 is a block diagram of the exemplary visual trick engine of FIGS. 1-5, in greater detail.

FIG. 7 is a block diagram of an alternative component of the exemplary visual trick engine.

FIG. 8 is a diagram of an example database of gesture inputs.

FIG. 9 is a diagram of an example mapping of gesture inputs to pre-packaged visual tricks.

FIG. 10 is a diagram of an example sequence of video frames for displaying a visual trick.

FIG. 11 is a diagram of an example single touch user input on a touch screen user interface.

FIG. 12 is a diagram of an example stroke movement user input on a touch screen user interface.

FIG. 13 is a diagram of exemplary kinematics applied to motion of virtual game components in a visual trick.

FIG. 14 is a diagram of kinematic effects applied to a visual trick that is executed across multiple video displays.

FIG. 15 is a flow diagram of an exemplary method of performing a visual trick for an electronic betting game

### DETAILED DESCRIPTION

Overview

This disclosure describes entertaining visual tricks for electronic betting games. As used herein, a visual trick is a movement of an image or video object virtually representing a physical artifact that would be used in non-electronic versions of a particular electronic betting game. For example, the physical artifact may be betting chips and the corresponding video object is then a digital image of the betting chips, or “virtual betting chips.” Generically, these video images of the physical artifacts used in a game are referred to herein as “virtual game components.” The movement of the image or video object—i.e., the virtual game component—can have a practical purpose, an entertaining purpose, or both.

During conventional game play, it is not uncommon for poker players and many other types of gamers and gamblers to manipulate gaming components—the physical artifacts used in non-electronic versions of the game—in an artful and skillful manner. Experienced players may perform skillful and entertaining maneuvers of the playing cards (“card tricks”), the betting chips (“chip tricks”), the dice (“dice tricks”), the tiles (“tile tricks”), and so forth to pass the time, relieve tension, impress onlookers, distract the opponents, demonstrate bravado, crush opponents' confidence, and to generate luck. For some, skillfully manipulating cards or chips with the fingers of one hand or two during a round of play is similar to doodling in order to pass the time, while others have developed the tricks to the point of a fine art, which provides a provocative sideshow to complement the main action of the betting game. Sometimes clever maneuvers reveal the player's hidden cards to the player—for a brief peek. In some localities it is even acceptable or at least tolerable for players to modify a game piece, such as tearing a playing card in half upon significantly losing or missing an opportunity in the game.

Exemplary systems and methods described herein digitally simulate live casino game play, and simulate player or host interactions with the physical artifacts that constitute betting game components. That is, an exemplary system simulates interactions with virtual betting chips, virtual dice, virtual balls, virtual dice cups, virtual playing cards, virtual game tiles, and so forth. An exemplary system can simulate simple movements and elegant tricks for player-die interactions, such as rolling the dice; shaking, throwing, and setting of a single die or multiple dice; player-chip interactions, such as placing or removing bets, throwing/tossing chips, and performing chip tricks; player-card interactions such as card peeking, tearing, bending, folding, and mucking of the cards; player-tile interactions such as placing or removing tiles, re-orienting tiles, spinning or flipping the tiles, etc.

The exemplary system can simulate the physical interactions that a player would perform and experience at a live casino gaming table, i.e., rendered in a digital electronic environment. Thus, via animation, the exemplary system simulates the feel of live game play on a digital platform.

An exemplary visual trick engine synthesizes both movements and tricks of the virtual game components, such as cards, chips, dice, tiles, etc. Such a visual trick engine creates 3-dimensional (3D) graphics on a 2-dimensional (2D) display or on a 3D display, if available. Audio effects, such as live game sounds including voices, in mono, stereo, and surround-sound, may accompany the visual tricks and image movements.

In one implementation or mode, the visual trick engine translates a user's gestures that are input via a user interface such as a touch screen display into simple movements and known tricks that are applied to the virtual game component.

In another or the same implementation, the visual trick engine enables the player to leverage some skill on the available user interfaces to invent and record new tricks for a given virtual game component.

In yet another or the same implementation, the visual trick engine applies the laws of kinematics—the branch of physics or mechanics that deals with objects in motion—to digitally simulate the touch, speed, direction, momentum, rotation, drag, friction, and collisions experienced by the real physical counterparts of the virtual game components. Such kinematic effects and trajectories, which may also be exaggerated or imaginary, can then be executed by the visual trick engine across one or more video displays of an electronic game platform. This can give the entertaining appearance, e.g., of sliding virtual playing cards all the way across a table, even though a single video display does not cover the entire tabletop.

The visual movement of a given virtual game component can be initiated by player, host, or combined player-host interaction with sensors or with images of the game components on a video display, e.g., via touch screen, mechanical button, or other input device (e.g., touching, dragging, mouse gesture, etc.). Or, the visual movement can be triggered by a computer-initiated sequence based on a random event, a fixed or random timer, game state, or game sequence.

The animations mapped from a player's input can be displayed through various mechanisms, such as linking to or synthesizing a video frame sequence that virtually emulates at least one virtual kinematic maneuver of the represented virtual game component to provide an entertaining visual effect. In the same or another implementation, the animations mapped from a player's input can be displayed by applying one or more mathematical operations to a model of a 2-dimensional or 3-dimensional physical artifact. Another animation mechanism includes applying one or more mathematical operations to one or more images of a 3-dimensional physical artifact, e.g., from a single camera directed toward the 3-dimensional artifact, or via stereo images obtained in real-time from one or more pairs of cameras directed toward the 3-dimensional artifact. Thus, animation can be via a stock video clip of an entire trick; and/or stock video clips of movements that can be combined on the fly to create tricks; and/or real-time mathematical modeling of 2-dimensional or 3-dimensional objects, including application of 2-dimensional or 3-dimensional kinematics to the animated motion of the portrayed objects. The kinematic formulas applied can be leveraged to create realistic motion or imaginary motion that is physically impossible but entertaining nonetheless.

The exemplary visual tricks engine to be described below may be included in electronic games, such as electronic game tables at which card games and casino games are played. For example, the games may include electronic poker, Blackjack, Baccarat, Pai Gow Poker, craps, roulette, and many other games, as played around an electronic game table in a card room or casino.

Exemplary Systems

The exemplary visual trick systems and methods to be described below can be used with wagering games, such as those games that are playable on multi-participant electronic game tables. For example, the exemplary visual trick systems and methods described herein can be used on table game platforms such as those described in U.S. Pat. No. 5,586,766 and U.S. Pat. No. 5,934,998 to Forte et al.; and U.S. Pat. No. 6,165,069, U.S. Pat. No. 7,048,629, and U.S. Pat. No. 7,255,642 to Sines et al., each of these incorporated herein by reference.

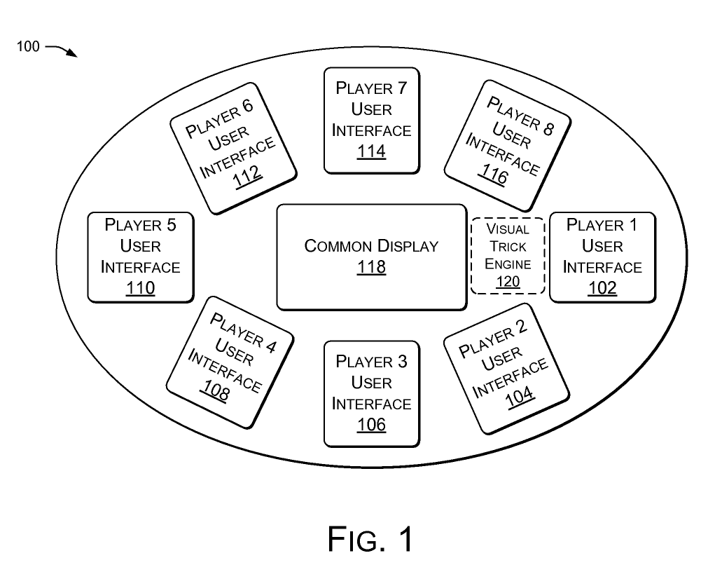

FIG. 1 shows an example layout of an electronic game table 100. The illustrated example game table 100 has an arbitrary size that in shown version seats eight participants maximum. Other implementations can seat a different number of participants. The game table 100 has a user interface for each participant, i.e., participant user interfaces 102, 104, 106, 108, 110, 112, 114, and 116. A participant's user interface 102 may consist of an electronic display for presenting visual images and may further consist of a touch screen display for interactive capability. Depending upon implementation, each participant user interface 102 may also include various other forms of interactive interface, such as pointing devices, light sensors, wagering chip sensors, audio speakers, etc.

The illustrated example game table 100 also includes a common display 118 in the center of the game table 100, for presenting visual information to all participants. The common display(s) 118 may present general information redundantly in two, four, or more visual orientations so that the displayed information is oriented correctly for each participant.

The example electronic game table 100 of FIG. 1 has an example layout that is useful for unhosted card games, although using a live dealer at game table 100 is not ruled out. The example game table 100 as shown typically uses virtual playing cards and virtual chips. However, the game table 100 can be configured to use any combination of real playing cards, virtual playing cards, real wagering chips, and/or virtual gaming chips. When real playing cards are used, a live shoe that reads the identity of each card sends the card identity information to the electronic processor (not shown) that runs the game. When real wagering chips are used, light sensors, optical sensors, scanning technology, weigh cells, RFID technology, etc., may be used with specially constructed chips or conventional standard chips to sense chip presence and chip values.

In FIG. 1, an exemplary visual trick engine 120 is located in or under the electronic game table 100 in the electronics of the game table 100. The visual trick engine 120 enables visual effects to be applied to virtual game components. The visual trick engine 120 is not limited to being in or under a table, such as the electronic game table 100. The visual trick engine 120 can be located in an arbitrary location, remote from the electronic game table. For example, the visual trick engine 120 can be remotely located via a network, for example, in a different location in the same building, or in a different building, or even in a different geographical region or country. A distributed version of the visual trick engine 120 may have its components spread across multiple different locations.

Likewise, in one implementation the visual trick engine 120 is not a discrete component or separate engine as shown in FIG. 1, but is integrated as part of a player's user interface (e.g., user interface 102) and is not necessarily physically separate hardware, software, or processes. That is, the hardware components and software processes that constitute the visual trick engine 120 may be part of the fabric of the hardware and software of the electronic game table 100 itself. However, the exemplary visual trick engine 120 in FIG. 1 is shown as an identifiable component (120) for the sake of description.

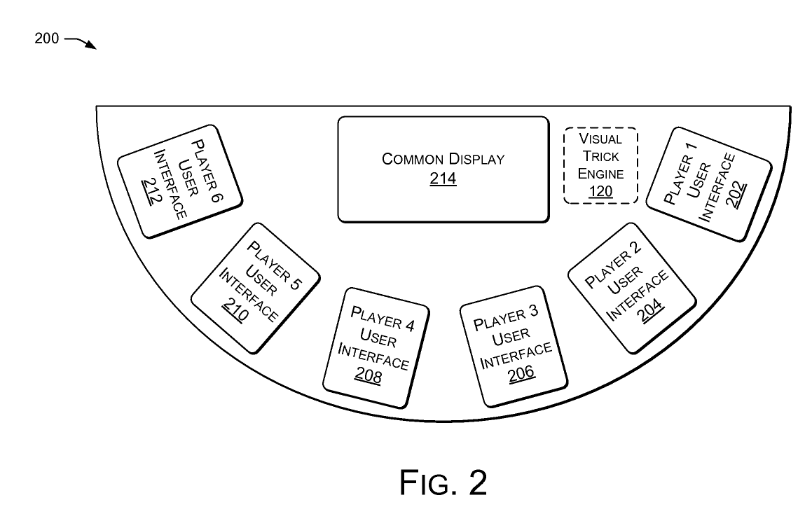

FIG. 2 shows another example layout of an electronic game table 200. In the illustrated example game table 200, multiple user interfaces 202, 204, 206, 208, 210, and 212 form a semi-circular array for seating participants. The participant user interfaces may consist of electronic visual displays with touch screen capability or other forms of user interface. The example game table 200 is shaped to accommodate a live dealer on the opposing side of the semi-circular array, but using a live dealer or host is not required. When the example game table 200 is not hosted, a common display 214 can be included on the side opposing the participants' semi-circle.

In FIG. 2, the exemplary visual trick engine 120 is located in or under the electronic game table 200 in the electronics of the game table 200. The visual trick engine 120 enables visual effects to be applied to virtual game components.

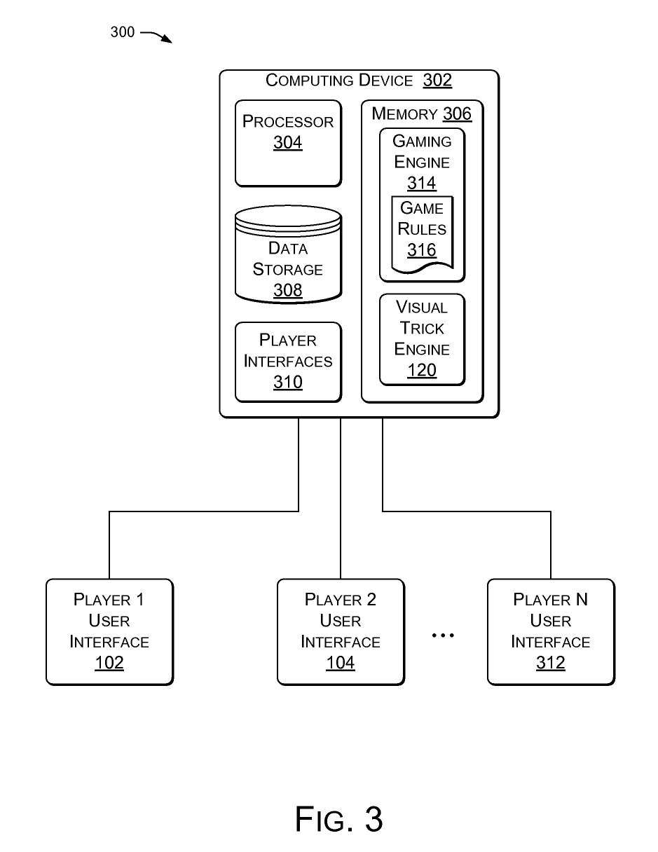

FIG. 3 shows an example game processing system 300 that can be included in game tables, such as electronic game tables 100 and 200. The game processing system 300 includes the exemplary visual trick engine 120. The illustrated configuration of the exemplary game processing system 300 is meant to provide only one example arrangement for the sake of overview. Many other arrangements of the illustrated components, or similar components, are possible within the scope of the subject matter. Such an exemplary game processing system 300 can be executed in hardware, or combinations of hardware, software, firmware, etc.

The exemplary game processing system 300 includes a computing device 302, which may be a desktop, server, or notebook style computer, or other device that has processor, memory, and data storage. The computing device 302 thus includes a processor 304, memory 306, data storage 308; and interface(s) 310 to communicatively couple with the participant “1” user interface 102, the participant “2” user interface 104, . . . , and the participant “N” user interface 312. The game processing system 300 includes a gaming engine 314, game rules 316, and the exemplary visual trick engine 120, shown as software loaded into memory 306.

The interfaces 310 can be one or more hardware components that drive the visual displays and communicate with the interactive components, e.g., touch screen displays, of the multiple participant user interfaces 102, 104, . . . , 312.

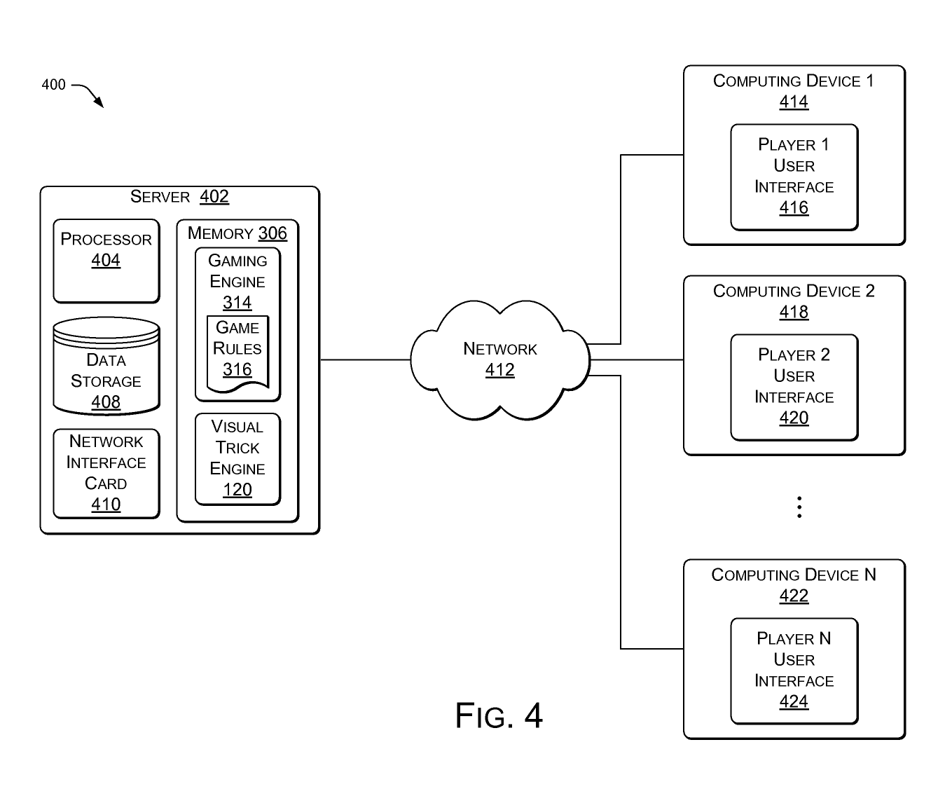

FIG. 4 shows another example game processing system 400 that can be included in the game tables, such as electronic game tables 100 and 200, or that can be implemented as a network of individual playing stations. The game processing system 400 includes the exemplary visual trick engine 120. The illustrated configuration of the exemplary game processing system 400 is meant to provide only one example arrangement for the sake of overview. Many other arrangements of the illustrated components, or similar components, are possible within the scope of the subject matter, e.g., that shown in FIG. 3. In FIG. 4, such an exemplary game processing system 400 can be executed in hardware, or combinations of hardware, software, firmware, etc.

The exemplary game processing system 400 includes a server computing device 402, which can be a computer or other device that has processor, memory, and data storage. The server computing device 402 thus includes a processor 404, memory 406, data storage 408, and an interface, such as a network interface card (NIC) 410, to communicatively couple over a network 412 with remote computing devices, such as computing device “1” 414 that hosts the participant “1” user interface 416; computing device “2” 418 that hosts the participant “2” user interface 420; . . . ; and computing device “N” 422 that hosts the participant “N” user interface 424. The game processing system 400 includes a gaming engine 314, game rules 316, and the exemplary visual trick engine 120, shown as software loaded into memory 406.

The participant computing devices 414, 418, and 422 may be desktop or notebook computers, or may be workstations or other client computing devices that have processor and memory, but may or may not have onboard data storage. Typically, a player station does not have data storage. Such modules may be “dumb” in that they have no bootable device, communicate with the game visual trick engine 120, but generally receive images and instructions from the server 402. Thus, in one implementation, a player computing device 414 is a visual display with graphics processing power and user interface components.

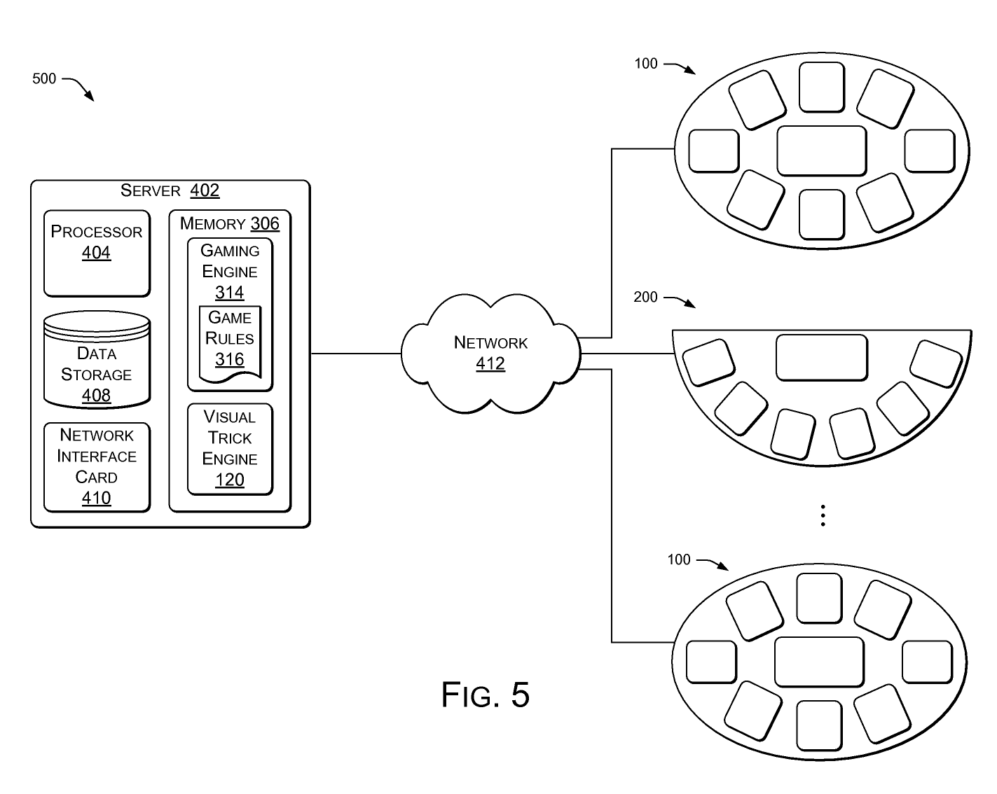

FIG. 5 shows another example game processing system 500, consisting of a network of gaming machines that each may have “n” players. The game processing system 500 is similar to that shown in FIG. 4, except that the client nodes of the network 412 are multiplayer gaming machines (e.g., 100 and 200) instead of individual gaming stations. That is, each node of the network 412 can accommodate multiple players. In another implementation, the network 412 has a mixture of client nodes consisting of individual playing stations as in FIG. 4 and multiplayer gaming stations as in FIG. 5.

Exemplary Engines

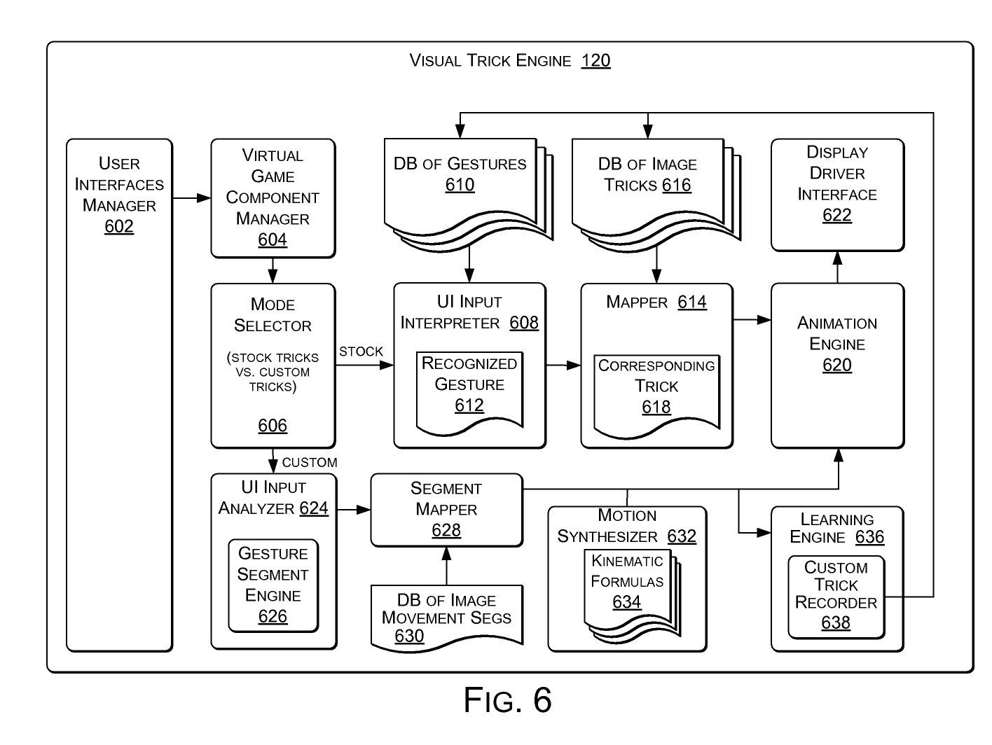

FIG. 6 shows the exemplary visual trick engine 120 of FIGS. 1-5 in greater detail. The illustrated configuration of the exemplary visual trick engine 120 is meant to provide only one example arrangement for the sake of overview. Many other arrangements of the illustrated components, or similar components, are possible within the scope of the subject matter. Such an exemplary visual trick engine 120 can be executed in hardware, or combinations of hardware, software, firmware, etc.

Components in the illustrated example implementation of the visual trick engine 120 include a user interfaces manager 602, a virtual game component manager 604, a mode selector 606, a user interface input interpreter 608, a database of gestures 610, a buffer for storing a recognized gesture 612, a mapper 614, a database of image tricks 616, a buffer for a mapped trick 618, an animation engine 620, and a display driver interface 622. The illustrated trick engine 120 further includes a user interface input analyzer 624, a gesture segmenting engine 626, a segment mapper 628, a database of image movement segments 630, a motion synthesizer 632, kinematic formulas 634, a learning engine 636, and a custom trick recorder 638. As mentioned, the above list of components can vary and the interrelation of these components can vary depending on implementation.

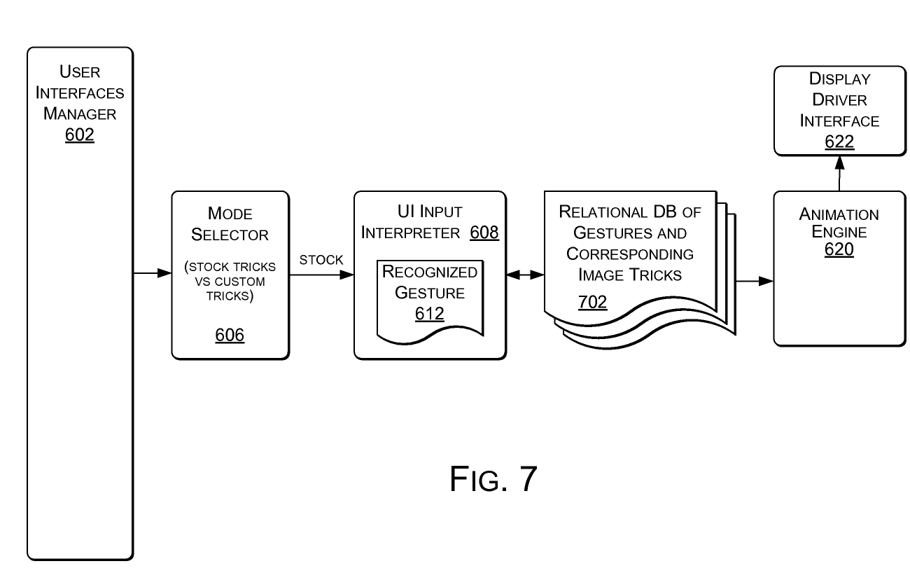

FIG. 7 shows a variation of the components in the visual trick engine 120. Instead of separately including the database of gestures 610 and the database of image tricks 616 as shown in FIG. 6, a relational database of gestures and corresponding image tricks 702 in FIG. 7 replaces the two databases 610 and 616 in FIG. 6. Thus, when the user interface input interpreter 608 determines a recognized gesture 612, (i.e., recognizes a finger gesture of a player calling for a particular trick), the image trick associated with the recognized gesture 612 is found in the relational database 702 using the recognized gesture 612 as a key. In FIG. 6, on the other hand, gestures and tricks are not necessarily paired or related to each other in a 1:1 manner.

Operation of the Exemplary Engine

The visual trick engine 120 can serve multiple functions, or, from another point of view, can operate in multiple modes. Thus, a mode selector 606 can direct certain lines of operation, but in one implementation the mode selector 606 changes modes on the fly, while in another implementation there is no mode selector 606, as the various modes of operation are built into the fabric of the visual trick engine 120.

In a first mode of operation, the visual trick engine 120 maps recognized finger gestures 612 to pre-packaged tricks, which may be stored as video clips representing a virtual game component undergoing the trick.

In a second mode of operation, there may or may not be pre-packaged tricks. Instead, the UI input analyzer 624 divides the user input into gesture segments and maps each segment to a plausible movement instruction or movement instruction segment. Thus, the player's gesture drives the motion of the virtual game component from scratch, and the custom trick recorder 638 can record an accumulation of the movement segments and store the segments as a novel trick in the database of tricks 616.

In a third mode of operation, a motion synthesizer 632 applies kinematic formulas 634 (laws of physics) to a mathematic model of the virtual game component undergoing a movement or trick. An initial velocity and/or momentum is typically assigned to the virtual game component based on the player's user interface input, and subsequent display of the virtual game component follows kinematic trajectories and behavior plotted by the kinematic formulas as they relate to mechanics, such as simulated interaction between a person's touch and a hypothetical surface of the modeled physical artifact; a velocity of the physical artifact, a momentum of the physical artifact, a friction acting on the physical artifact, a drag acting on the physical artifact, a gravitational force acting on the physical artifact, a rotational inertia possessed by the physical artifact, and one or more collision forces acting on the physical artifact.

In one implementation, an electronic game table (e.g., 100) utilizing the visual trick engine 120 can recognize an extensive repertoire of gestures 610 (e.g., finger or hand gestures) made by the human player (or dealer) and the mapper 614 can relate each recognized gesture 612 to a library of preprogrammed image tricks 616 or manipulations. For example, the image manipulations may be virtual renditions of visually entertaining playing card maneuvers (e.g., a one hand shuffle); chip tricks, or sophisticated dice rolls and dice tricks.

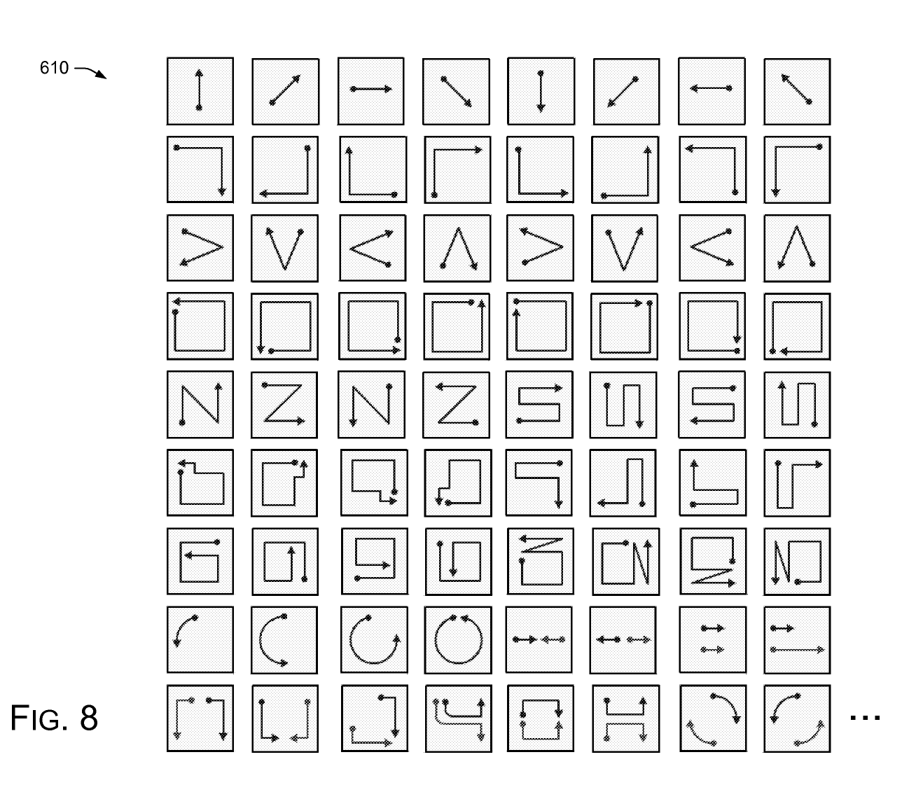

FIG. 8 shows an example or sample database of gestures 610. In FIG. 8, a “dot” designates the origin of a finger gesture on a touch screen display and the arrowhead represents the direction of performing the gesture. When there are two arrows shown in a particular gesture, the two parts of the gesture represented by the two arrows can be performed by two different fingers, or in some implementations by the same finger acting twice on a certain part of the display screen and within a certain time interval. The database of gestures 610 shown in FIG. 8 is large enough to enable the visual trick engine 120 to perform 72 tricks or variations of tricks per virtual game component. The database of gestures 610 can be scaled to fit the betting game being played or the sophistication of the electronic game table 100.

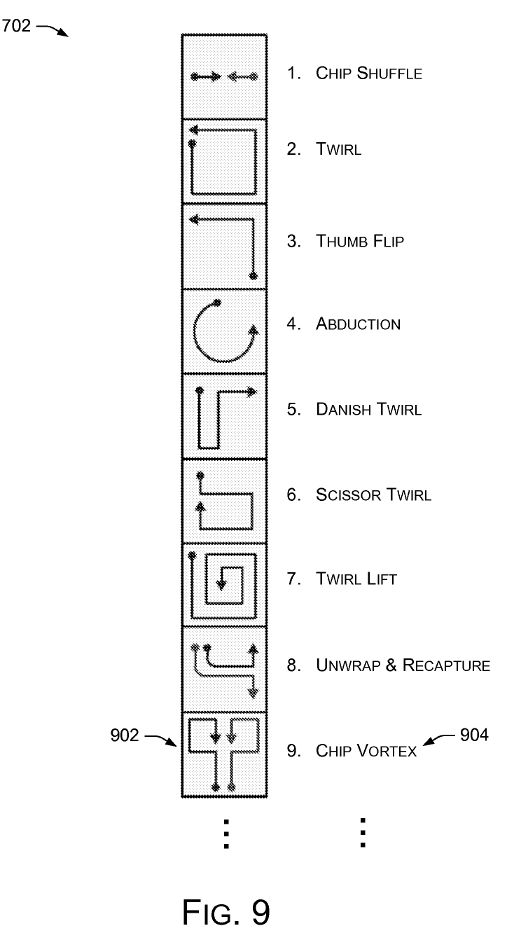

FIG. 9 shows a sample mapping of some of the gestures from the database of gestures 610 to movement instructions for tricks—in this case, chip tricks. For example, “9” shows the gesture 902 for the player's finger(s) to designate a “chip vortex” chip trick 904. The chip vortex is an innovative chip trick introduced herein. Tricks executed by the visual trick engine 120 typically simulate live casino game play, but in one implementation a trick performed by the visual trick engine 120 is not required to follow the laws of physics or to be humanly performable. A virtual chip trick need only be displayable on a video display.

The chip vortex 904 has a gesture component 902 as shown. The trick component of the chip vortex 904 is virtually displayed as one or more stacks of virtual chips that appear to “explode” as if by an invisible bomb beneath them. None of the chips are visually destroyed, but burst out from the center in all directions of 3D space, as displayed on a 2D video display. Then, as the chips are exploding out, the chips come to a slow, smooth halt, as if an invisible vortex is pulling them back to their place of origin. When they reach the maximum explosive volume, the chips continue to rotate a little longer in 3D space, then are quickly sucked by the invisible vortex back to their starting place.

Other chip tricks and their variations are well-known by name. Some of these known chip tricks are described above as introductory or background material.

Alternatively, FIG. 9 also shows a sample part of the relational database 702 of FIG. 7, which associates or pre-maps particular recognized gestures 612 with corresponding tricks 616. In FIG. 6, by contrast, the mapper 614 uses the recognized gesture 612 to search for a trick, e.g., by applying a best-effort attempt to determine some similarity between the gesture and one of the stored tricks in the database of tricks 616. However, in FIG. 6 the number of gestures in the database of gestures 610 may be different from the number of tricks in the database of tricks 616, so that there is not necessarily a 1:1 correspondence between a recognized gesture 612 and the trick that will be performed in association with the gesture. In FIG. 7, instead of a search, the recognized gesture 612 is used as a key to directly address the indexed relational database 702. That is, the recognized gesture 612 is used as a pointer to one of the records in the relational database 702 so that if the UI input interpreter 608 finds a recognized gesture 612 then the corresponding trick exists and will be reproducibly selected and performed each time the same recognized gesture 612 is found.

A pre-programmed trick, e.g., a standard chip trick, may be stored in the database of tricks 616 or in the relational database 702 as one or more movement instructions for the particular virtual game component, such as virtual playing card or virtual chip. The movement instructions may be commands and screen coordinates for sequentially posting a video object in order to simulate motion, or the movement instructions may be one or more motion vectors for creating a sequence of video frames to animate the motion of the virtual game component. Or, the movement instructions may be a stored video sequence or video clip that can be played to create the visual animation that constitutes the trick.

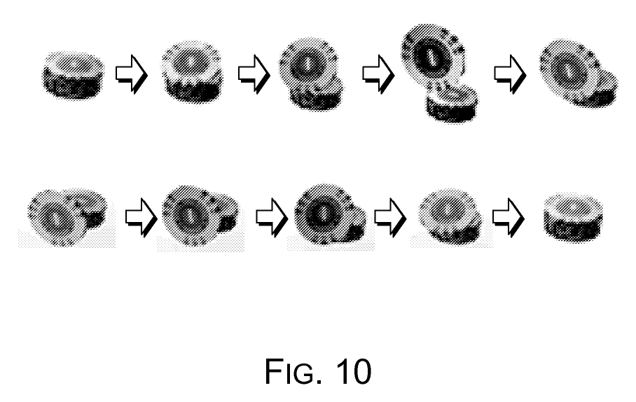

FIG. 10 shows a sequence of ten video frames, a short video clip, that represents the movement instructions for the “bounce” chip trick. The video clip or a pointer to the video clip can be stored in the database of image tricks 616 or in the relational database 702. Corresponding audio effects can be stored with each movement instruction or each trick in the database of image tricks 616 or in the relational database 702.

Returning to FIG. 6, the user interfaces manager 602 may multiplex input from multiple input devices of multiple players, such as the multiple video displays 102 . . . 116 of the particular electronic game table 100 in use. The user interfaces manager 602 may also track or filter which sections of a particular touch screen display can be used by the player to perform tricks and which sections are inactive or forbidden.

The virtual game component manager 604 may filter which user inputs correspond to particular virtual game components. That is, when a particular implementation enables visual tricks for more than one type of virtual game component. For example, a particular betting game may allow the players to perform visual tricks for both the betting chips and the playing cards.

The mode selector 606, as describe above, can direct certain lines of operation. In one implementation the mode selector 606 changes modes on the fly, while in another implementation there is no mode selector 606, as the various modes of operation can be built into the fabric of the visual trick engine 120. The mode selector 606 can change from mapping player gestures to pre-packaged tricks, to mapping the gestures directly to movements that have some correspondence with the parts of the gestures.

In one implementation or mode, upon receiving user input, the user interface input interpreter 608 may consult a database of gestures 610 to attempt determination of a recognized gesture 612. The mapper 614 aims to find a corresponding trick 618 for the recognized gesture from the database of image tricks 616. The trick to be performed is passed to the animation engine 620, which sends display control signals to the display driver interface 622.

In another implementation or mode, the UI input analyzer 624 has a gesture segmenting engine 626 that divides the user input into gesture segments. The segment mapper 628 relates each gesture segment to a plausible movement instruction or movement instruction segment from the database of image movement segments 630. An accumulation of these movement segments can be passed to the animation engine 620 to perform the trick. A learning engine 636 can derive an innovative new trick from the movement segments established, and/or the custom trick recorder 638 can add the novel trick to the database of gestures 610 and the database of image tricks 616, or to the relational database 702 that relates gestures to tricks.

In another implementation or mode, as introduced above, the motion synthesizer 632 applies kinematic formulas 634 (laws of physics) to a mathematic model of the virtual game component undergoing a movement or trick. An initial velocity and/or momentum is typically assigned to the virtual game component based on the player's user input, and subsequent display of the virtual game component follows kinematic trajectories and behavior plotted by the kinematic formulas as they relate to mechanics, such as simulated interaction between a person's touch and a hypothetical surface of the modeled physical artifact that is the subject of the virtual game component; a velocity of the physical artifact, a momentum of the physical artifact, a friction acting on the physical artifact, a drag acting on the physical artifact, a gravitational force acting on the physical artifact, a rotational inertia possessed by the physical artifact, and one or more collision forces acting on the physical artifact.

A typical system has an electronic game table 100 with multiple video displays 102 . . . 116, a visual trick engine 120 for receiving an input from a user interface (e.g., 102) of the electronic game table 100, and a mapper 614 in the visual trick engine 120 to relate the input to a movement instruction for a video object representing a physical artifact used in the betting game played on the electronic game table 100. An animation engine 620 displays the video object in multiple video frames displayed on one or more of the multiple video displays 102 according to the movement instruction.

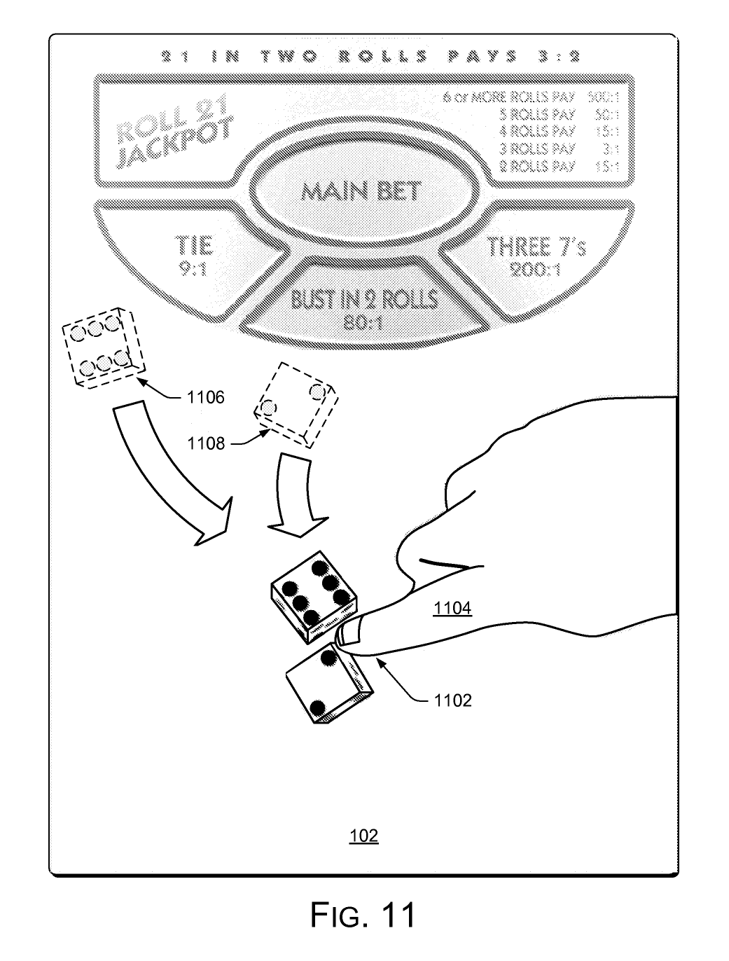

As shown in FIG. 11, the visual trick engine 120 may receive an input, e.g., from a touch screen display 102 of the electronic game table 100. The mapper 614 may relate an input signal generated from a single touch 1102 of the finger 1104 on the touch screen display 102 to a motion vector for the video object. For example, in one trick, a single touch of the finger 1102 on the touch screen display 102 causes the dice 1106 and 1108 to roll or tumble from a relatively large distance away, to the place where the finger 1104 is merely touching the touch screen display 102.

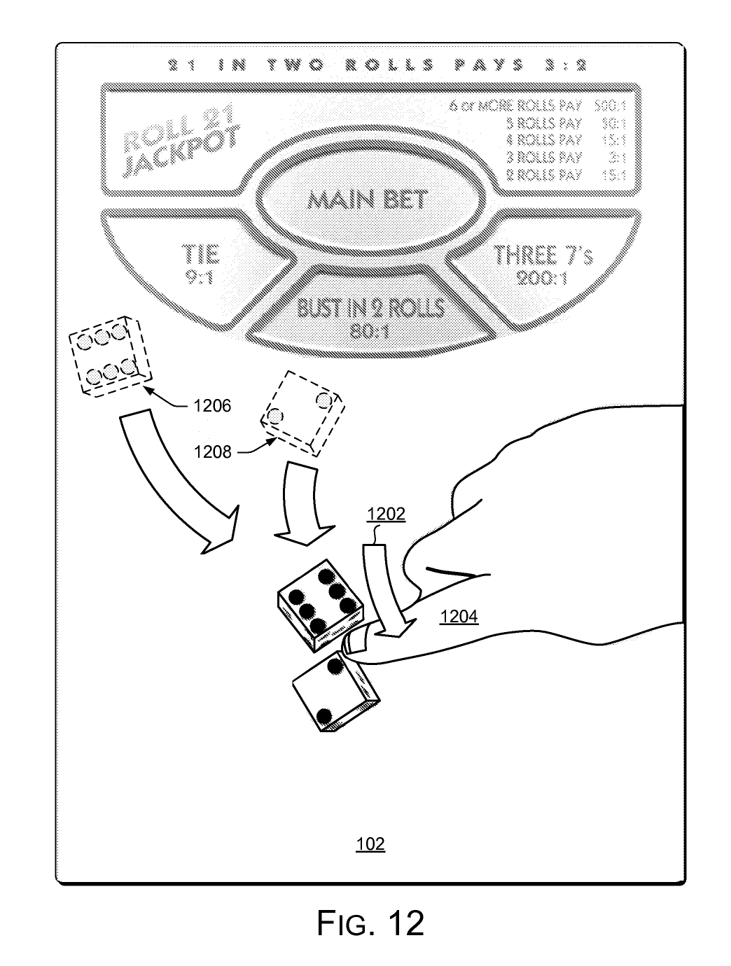

Or, as shown in FIG. 12, the mapper 614 relates an input signal generated from a moving input gesture 1202 on the touch screen display 102 to one or more motion vectors and/or tricks for the video object. Usually the motion vectors are related to the movement quality and quantity of the input gesture. For example, in one trick, a short sweep of the finger 1204 on the touch screen display 102 causes the dice 1206 and 1208 to roll or tumble from a relatively large distance away, to the place where the finger 1204 is sweeping the touch screen display 102.

In one implementation, the mapper 614 matches the input to a video sequence as in FIG. 10, that represents the movement instruction for the video object representing the physical artifact. The video sequence may further represent a 3-dimensional movement instruction for the video object.

The video object can virtually represent a playing card, a betting chip, a die, a pair of dice 1106 and 1108 as shown in FIG. 11, a dice cup, a ball, a game tile, a domino, slot reel, slot machine symbol, marble, spinning wheel, etc. When the video object represents a virtual betting chip, the movement instruction retrieved from the database 616 can be visual actions for performing a trick associated with the betting chip, such as a five chip coin star, an abduction, an Areat shuffle, a back spin, a bounce back, a bounce, a butterfly, a caterpillar, a caterpillar star, a chip roll, a chip vortex, a Danish twirl, a drifter, a drop bounce, a finger-to-finger twirl, a finger flip, a finger roll, a floater, a fountain, a J-factor, a Johnny Chan, a knuckle roll, a lift twirl, a lookout, a Mexican jumping chip, a moon landing, a muscle pass, a pendulum, a Phil Ivey stepup, a pick, a pickover, a reverse thumb flip, a roll down, a run around, a scissor twirl, a shuffle, a sweep, a swirl, a switch, a swivel display, a sub-zero, a thumb flip, a top spin, a twirl, a twirl hop, a twirl lift, or an unwrap-and-recapture. The visual trick engine 120 can simulate at least part of a human hand when displaying one of the tricks.

Likewise, the video object can represent one or more virtual playing cards, and the movement instruction retrieved from the database can comprise visual actions of a playing card maneuver for the one or more playing cards, such as shuffling the playing cards, cutting a deck of the playing cards, dealing a playing card, discarding a playing card, passing a playing card, revealing a playing card, changing a size of the playing card, or tearing a playing card.

The motion synthesizer 632 in the visual trick engine 120 can apply one or more laws of physics to the movement instruction. The motion synthesizer can derive a kinematic motion for the video object by applying the one or more laws of physics via kinematic formulas 634 to a mathematical model of the physical artifact represented by the video object.

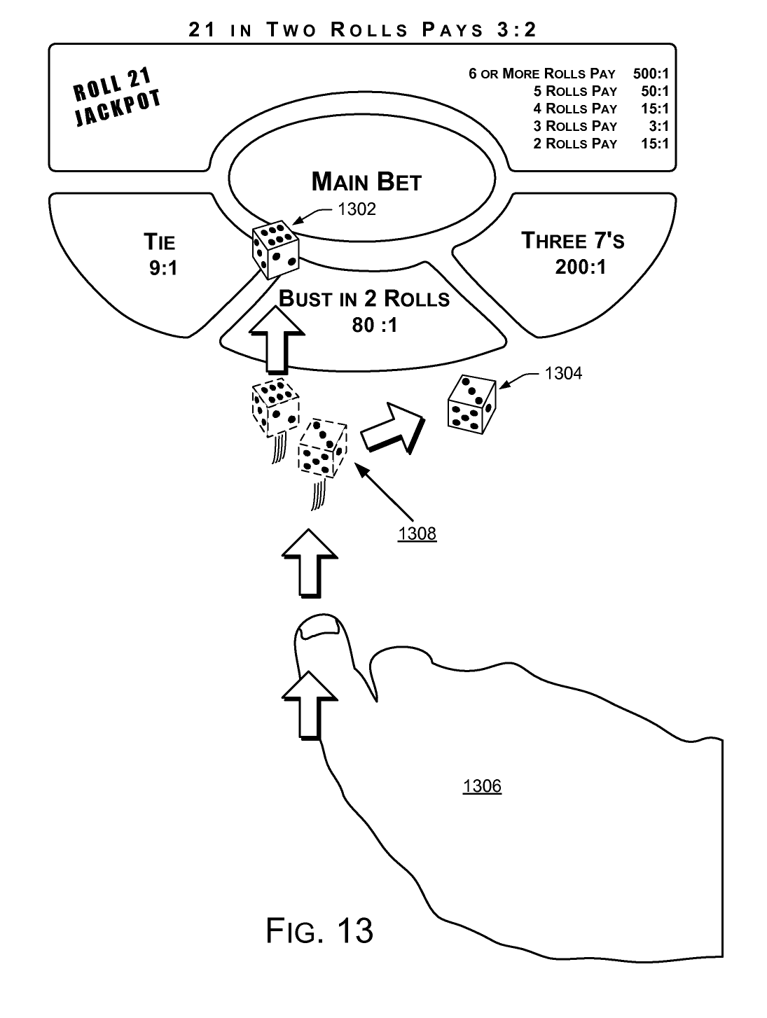

The motion synthesizer 632 may derive the kinematic motion for the video object by applying a mathematical formula describing an interaction between a person initiating the motion and a surface of the physical artifact, a velocity, a momentum, a friction, a drag, a gravitational force, a rotational inertia, and a collision force acting on the physical artifact. For example, as shown in FIG. 13, gravitation, momentum, friction, and rotation dynamics are all applied to a mathematical model of the virtual dice 1302 and 1304. The mathematical model may include the mass, size, shape, hardness, etc., of the dice 1302, 1304. Thus, the virtual dice 1302 and 1304 are “cast” by the real hand 1306 of a player touching and performing a finger movement on the touch screen display 102. One die 1304 of the pair of virtual dice 1302 and 1304 takes a “bad bounce” as modeled by the kinematic formulas 634, at a location 1308 on the touch screen display 102 because the virtual die 1304 catches an edge or corner on the mathematical surface and the die 1304 veers off sharply. Such kinematically realistic image effects greatly add to the enjoyment of the betting game.

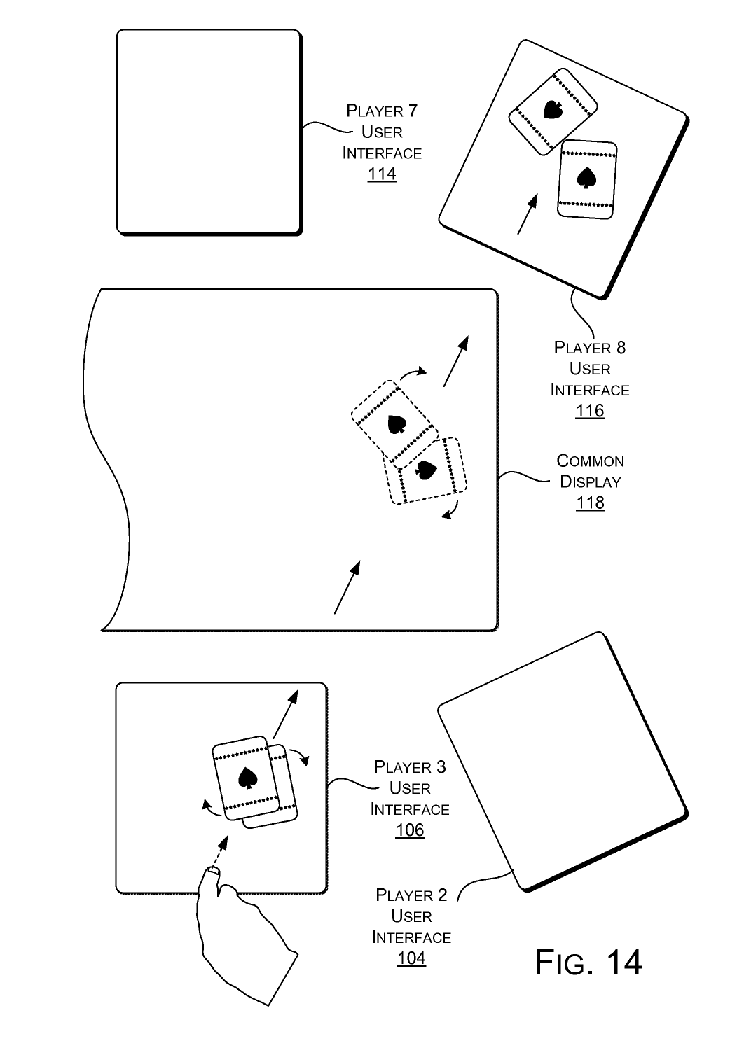

As shown in FIG. 14, the visual trick engine 120 can display the kinematic motion of the video object across more than one of the multiple video displays 102 . . . 116. For example, FIG. 14 shows a part of the tabletop of the electronic game table of FIG. 1. Player 3 and Player 8 have corresponding user interfaces 106 and 116, and sit on opposite sides of a common display 118 that is positioned between the player 3 user interface 106 and the player 8 user interface 116. When player 3 gestures for two virtual playing cards to be passed in a spinning manner to player 8, the gesture imparts an initial linear speed to the playing cards and an initial speed of rotation. The virtual playing cards travel a path across the game table 100 appearing first on the player 3 user interface 106, then on the common display 118, and then on the player 8 user interface 116, spinning as they travel. The motion synthesizer 632 applies the kinematic formulas 634 to the cards, so that the friction that would be present if the cards were physically real, decreases the speed of each virtual playing card as it travels the path, adding realism to the visual effect. Likewise, the spinning motion of each card decelerates just as physically real playing cards would decrease spinning if subjected to the same initial motions.

Example Method

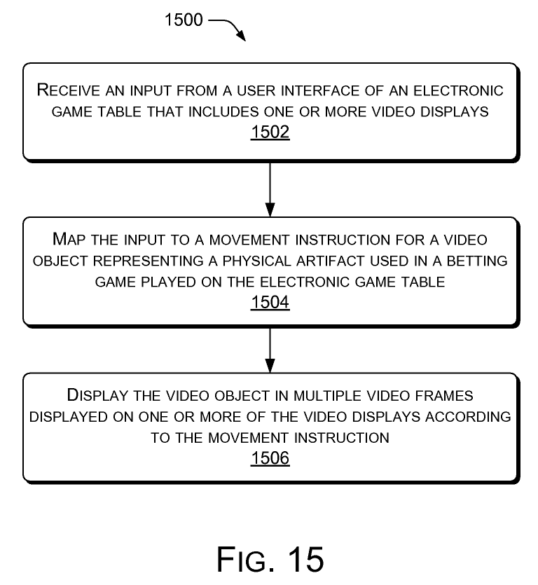

FIG. 15 shows an exemplary computer-executable method 1500 of performing a visual trick for an electronic betting game. In the flow diagram, the operations are summarized in individual blocks. The exemplary method 1500 may be performed by hardware, or combinations of hardware, software, firmware, etc., for example, by components of the exemplary visual trick engine 120.

At block 1502, an input from a user interface of an electronic game table that includes one or more video displays is received. In one implementation, the method 1500 receives the input from a touch screen display of the electronic game table. The input may be one or more single touch contacts between a finger and the touch screen, and/or may be one or more movements or strokes of one or more fingers or hand parts on a given touch screen user interface.

At block 1504, the input is mapped to a movement instruction for a video object representing a physical artifact used in a betting game played on the electronic game table. For example, an electronic table game system can map segments of hand gestures to segments of image movement, so that a player may perform—or attempt-a custom or new visual trick (e.g., a chip trick) in real-time. That is, the electronic table game system implements the player's arbitrary finger (hand, etc.) gestures as a custom image trick. The appeal and sophistication of the virtual image trick depends on the player's learned skill at performing the trick, for example, via the exemplary visual trick engine of the electronic table game system. In one implementation, the exemplary visual trick engine combines mouse-like macro-movement of an image (by the player) with more subtle manipulation of the moving image, based on subtle or skilled hand or finger gestures.

The exemplary visual trick engine may record new tricks by extending a “recording” or “recording trick” mode to the player. In such an implementation, the player can actuate a recording switch (e.g., a visual icon) and begin recording an image trick as the player performs finger and hand gestures that are translated by the visual tricks engine into visual tricks of artifacts, such as playing cards, betting chips, or dice. Once perfected, the recorded trick may be stored as a macro composed of smaller image movements and motions, stored in the player's (or the system's) collection, library, or database of tricks.

The method 1500 may include matching the input to a video sequence representing a 3-dimensional movement instruction for the video object representing the physical artifact. The video object can virtually represent a playing card, a betting chip, a die, a pair of dice, a dice cup, a ball, a game tile, a domino, or a slot machine symbol, etc.

The mapping may include searching a database of gestures for a representation of the input and retrieving a corresponding movement instruction for the video object from the database. The video object may represent one or more virtual betting chips; and then the movement instruction retrieved from the database comprises visual actions of a trick for the betting chip, such as a five chip coin star, an abduction, an Areat shuffle, a back spin, a bounce back, a bounce, a butterfly, a caterpillar, a caterpillar star, a chip roll, a Danish twirl, a drifter, a drop bounce, a finger-to-finger twirl, a finger flip, a finger roll, a floater, a fountain, a J-factor, a Johnny Chan, a knuckle roll, a lift twirl, a lookout, a Mexican jumping chip, a moon landing, a muscle pass, a pendulum, a Phil Ivey stepup, a pick, a pickover, a reverse thumb flip, a roll down, a run around, a scissor twirl, a shuffle, a sweep, a swirl, a switch, a swivel display, a sub-zero, a thumb flip, a top spin, a twirl, a twirl hop, a twirl lift, or an unwrap-and-recapture.

The method 1500 may include simulating at least part of a human hand for display when displaying one of the tricks. When the video object represents one or more virtual playing cards, the movement instruction retrieved from the database can be visual actions of a playing card maneuver for the one or more playing cards, such as shuffling the playing cards, cutting a deck of the playing cards, dealing a playing card, discarding a playing card, passing a playing card, revealing a playing card, changing a size of the playing card, or tearing a playing card.

Further, the mapping may include applying one or more laws of physics to the movement instruction. Applying a law of physics to the movement instruction can further includes deriving a kinematic motion for the video object by applying the one or more laws of physics to a mathematical model of the physical artifact represented by the video object. Mathematical formulas for imparting kinematic motion may include those for describing an interaction or touch between a person and a surface of the physical artifact, a velocity of the physical artifact, a momentum of the physical artifact, a friction acting on the physical artifact, a drag acting on the physical artifact, a gravitational force acting on the physical artifact, a rotational inertia possessed by the physical artifact, and a collision force acting on the physical artifact.

In one implementation, the method 1500 includes dividing the input into input gesture segments, mapping each input gesture segment to a movement instruction segment for the video object, and displaying the video object according to an accumulation of the movement instruction segments; as well as recording the input gesture segments and the accumulation of the movement instruction segments and storing the input gesture segments with the associated accumulation of the movement instruction segments in a relational database—thus creating a custom trick addressable in the relational database.

At block 1506, the video object is displayed in multiple video frames displayed on one or more of the multiple video displays according to the movement instruction. The user interface for sensing player gestures, such as hand and finger motions, may be the same user interface that displays an instance of the visual trick being performed, i.e., when the display screen is also a touch screen for sensing user input. Or, the user interface for sensing player gestures may be composed of optical sensors, motion sensors, accelerometers, or even touch sensors worn on the hand like part of a glove.

Movement of virtual game components and visual tricks may be executed on one display, or across multiple displays. For example, a card dealer may touch a first touch screen to pass virtual playing cards from the first screen to a second screen of another card player. Likewise, a first player in a virtual dice game may touch an input device, such as a touch screen, to throw the dice from the first player's screen, across a common display positioned between all players, to a second player's display on an opposing side of the common screen.

### CONCLUSION

Although exemplary systems have been described in language specific to structural features and/or methodological acts, it is to be understood that the subject matter defined in the appended claims is not necessarily limited to the specific features or acts described. Rather, the specific features and acts are disclosed as exemplary forms of implementing the claimed systems, methods, and structures.

1. A computer-executable method, comprising:
receiving an input from a user interface of an electronic game table that includes one or more video displays;
mapping the input to a movement instruction for a video object virtually representing a physical artifact used in a betting game played on the electronic game table;
displaying an animation of the video object on one or more of the multiple video displays according to the movement instruction; and
wherein the animation comprises at least one virtual kinematic maneuver of the represented physical artifact to create an entertaining visual effect.

2. The computer-executable method as recited in claim 1, wherein receiving an input includes receiving an input from one of a touch screen display, a sensor, a light sensor, a pressure sensor, a touch sensor, a proximity sensor, a switch, a button switch, a mouse, a keyboard, a track ball, or a user interface icon.

3. The computer-executable method as recited in claim 1, wherein the mapping includes relating an input signal generated from a sequence of interactions with light sensors to a motion vector for the video object.

4. The computer-executable method as recited in claim 1, wherein the mapping includes relating an input signal generated from a single touch or a multi-touch of a touch screen display to a motion vector for the video object.

5. The computer-executable method as recited in claim 1, wherein the mapping includes relating an input signal generated from a moving touch of a touch screen display to a motion vector for the video object, wherein the motion vector is related to the moving touch.

6. The computer-executable method as recited in claim 1, wherein the mapping includes applying a mathematical operation to a model of a 2-dimensional or 3-dimensional physical artifact.

7. The computer-executable method as recited in claim 1, wherein the mapping includes applying a mathematical operation to one or more images of a 3-dimensional physical artifact, wherein the one or more images comprise one of:
images obtained in real-time from a single camera directed toward the 3-dimensional physical artifact; or
stereo images obtained in real time from one or more pairs of cameras directed toward the 3-dimensional physical artifact.

8. The computer-executable method as recited in claim 1, wherein the mapping includes matching the input to a video sequence that represents the movement instruction for the video object representing the physical artifact.

9. The computer-executable method as recited in claim 8, wherein the mapping includes matching the input to a video sequence representing a 3-dimensional movement instruction for the video object virtually representing the physical artifact.

10. The computer-executable method as recited in claim 1, wherein the video object virtually represents one of a playing card, a betting chip, a die, a pair of dice, a dice cup, a ball, a game tile, a domino, a slot reel, a slot machine symbol, a marble, or a spinning wheel.

11. The computer-executable method as recited in claim 1, wherein the mapping includes searching a database of gestures for a representation of the input and retrieving a corresponding movement instruction for the video object from the database.

12. The computer-executable method as recited in claim 11, wherein the video object represents one or more virtual betting chips; and
wherein the movement instruction retrieved from the database comprises visual actions of a trick for the betting chip, the trick comprising one of:
a five chip coin star, an abduction, an Areat shuffle, a back spin, a bounce back, a bounce, a butterfly, a caterpillar, a caterpillar star, a chip roll, a Danish twirl, a drifter, a drop bounce, a finger-to-finger twirl, a finger flip, a finger roll, a floater, a fountain, a J-factor, a Johnny Chan, a knuckle roll, a lift twirl, a lookout, a Mexican jumping chip, a moon landing, a muscle pass, a pendulum, a Phil Ivey stepup, a pick, a pickover, a reverse thumb flip, a roll down, a run around, a scissor twirl, a shuffle, a sweep, a swirl, a switch, a swivel display, a sub-zero, a thumb flip, a top spin, a twirl, a twirl hop, a twirl lift, or an unwrap-and-recapture.

13. The computer-executable method as recited in claim 12, further comprising simulating at least part of a human hand for display when displaying one of the tricks.

14. The computer-executable method as recited in claim 11, wherein the video object represents one or more virtual playing cards; and
wherein the movement instruction retrieved from the database comprises visual actions of a playing card maneuver for the one or more playing cards, the visual actions comprising the playing card maneuver comprising one of:
shuffling the playing cards, cutting a deck of the playing cards, dealing a playing card, discarding a playing card, passing a playing card, revealing a playing card, changing a size of the playing card, or tearing a playing card.

15. The computer-executable method as recited in claim 1, wherein the mapping includes applying one or more laws of physics to the movement instruction.

16. The computer-executable method as recited in claim 15, wherein applying the one or more laws of physics to the movement instruction further includes deriving a kinematic motion for the video object by applying the one or more laws of physics to a mathematical model of the physical artifact represented by the video object.

17. The computer-executable method as recited in claim 16, further comprising displaying the kinematic motion of the video object across more than one of the one or more video displays.

18. The computer-executable method as recited in claim 16, wherein applying the one or more laws of physics to the mathematical object of the physical artifact includes applying a mathematical formula describing one of a touch between a person and a surface of the physical artifact, a velocity of the physical artifact, a momentum of the physical artifact, a friction acting on the physical artifact, a drag acting on the physical artifact, a gravitational force acting on the physical artifact, a rotational inertia possessed by the physical artifact, and a collision force acting on the physical artifact.

19. The computer-executable method as recited in claim 1, further comprising:
dividing the input into input gesture segments;
mapping each input gesture segment to a movement instruction segment for the video object; and
displaying the video object according to an accumulation of the movement instruction segments.

20. The computer-executable method as recited in claim 19, further comprising:
recording the input gesture segments and the accumulation of the movement instruction segments; and
storing the input gesture segments with the associated accumulation of the movement instruction segments in a relational database.

21. The computer-executable method as recited in claim 20, wherein the stored input gesture segments and the associated accumulation of the movement instruction segments comprise a custom trick addressable in the relational database.

22. A system, comprising:
an electronic game table;
one or more video displays in the electronic game table;
a visual trick engine for receiving an input from a user interface of the electronic game table;
a mapper in the visual trick engine to relate the input to a movement instruction for a video object representing a physical artifact used in a betting game played on the electronic game table; and
an animation engine to display the video object in multiple video frames displayed on one or more of the video displays according to the movement instruction.

23. The system as recited in claim 22, wherein the visual trick engine receives an input from a touch screen display of the electronic game table.

24. The system as recited in claim 23, wherein the mapper relates an input signal generated from a single touch on the touch screen display to a motion vector for the video object.

25. The system as recited in claim 23, wherein the mapper relates an input signal generated from a moving input gesture on the touch screen display to a motion vector for the video object, wherein the motion vector is related to the moving input gesture.

26. The system as recited in claim 22, wherein the mapper matches the input to a video sequence that represents the movement instruction for the video object representing the physical artifact.

27. The system as recited in claim 26, wherein the mapper matches the input to a video sequence representing a 3-dimensional movement instruction for the video object representing the physical artifact.

28. The system as recited in claim 22, wherein the video object virtually represents one of a playing card, a betting chip, a die, a pair of dice, a dice cup, a ball, a game tile, a domino, or a slot machine symbol.

29. The system as recited in claim 22, wherein the mapper searches a database of gestures for a representation of the input and retrieves a corresponding movement instruction for the video object from the database.

30. The system as recited in claim 29, wherein the video object represents one or more virtual betting chips; and
wherein the movement instruction retrieved from the database comprises visual actions for performing a trick associated with the betting chip, the trick comprising a chip vortex.

31. The system as recited in claim 29, wherein the video object represents one or more virtual betting chips; and
wherein the movement instruction retrieved from the database comprises visual actions for performing a trick associated with the betting chip, the trick comprising one of:
a five chip coin star, an abduction, an Areat shuffle, a back spin, a bounce back, a bounce, a butterfly, a caterpillar, a caterpillar star, a chip roll, a Danish twirl, a drifter, a drop bounce, a finger-to-finger twirl, a finger flip, a finger roll, a floater, a fountain, a J-factor, a Johnny Chan, a knuckle roll, a lift twirl, a lookout, a Mexican jumping chip, a moon landing, a muscle pass, a pendulum, a Phil Ivey stepup, a pick, a pickover, a reverse thumb flip, a roll down, a run around, a scissor twirl, a shuffle, a sweep, a swirl, a switch, a swivel display, a sub-zero, a thumb flip, a top spin, a twirl, a twirl hop, a twirl lift, or an unwrap-and-recapture.

32. The system as recited in claim 31, wherein the visual trick engine simulates at least part of a human hand for display when displaying one of the tricks.

33. The system as recited in claim 29, wherein the video object represents one or more virtual playing cards; and
wherein the movement instruction retrieved from the database comprises visual actions of a playing card maneuver for the one or more playing cards, the playing card maneuver comprising one of:
shuffling the playing cards, cutting a deck of the playing cards, dealing a playing card, discarding a playing card, passing a playing card, revealing a playing card, changing a size of the playing card, or tearing a playing card.

34. The system as recited in claim 22, further comprising a motion synthesizer in the visual trick engine to apply one or more laws of physics to the movement instruction.

35. The system as recited in claim 34, wherein the motion synthesizer derives a kinematic motion for the video object by applying the one or more laws of physics to a mathematical model of the physical artifact represented by the video object.

36. The system as recited in claim 35, wherein the visual trick engine displays the kinematic motion of the video object across more than one of the video displays.

37. The system as recited in claim 35, wherein the motion synthesizer derives the kinematic motion for the video object by applying to the mathematical model of the physical artifact a mathematical formula describing one of a touch between a person and a surface of the physical artifact, a velocity of the physical artifact, a momentum of the physical artifact, a friction acting on the physical artifact, a drag acting on the physical artifact, a gravitational force acting on the physical artifact, a rotational inertia possessed by the physical artifact, and a collision force acting on the physical artifact.

38. The system as recited in claim 22, further comprising custom trick components, including:
a user interface input analyzer to divide the input into gesture segments;
a segment mapper to relate each gesture segment to a movement instruction segment for the video object; and
wherein the animation engine displays the video object according to an accumulation of the movement instruction segments.

39. The system as recited in claim 38, further comprising:
a learning engine to record the gesture segments and the accumulation of the movement instruction segments; and
a relational database to store the gesture segments with the associated accumulation of the movement instruction segments.

40. The system as recited in claim 39, wherein the stored gesture segments and the associated accumulation of the movement instruction segments comprise a custom trick addressable in the relational database.
